(19) United States
(12) Patent Application Publication
(10) Pub. No.: US 2008/0094828 A1
(43) Pub. Date: Apr. 24, 2008

(54) Light-emitting diode lamp bank

(76) Inventor: Shu-Fa Shao, Lu-Chou City (TW)

Correspondence Address: TROXELL LAW OFFICE PLLC, SUITE 1404, 5205 LEESBURG PIKE, FALLS CHURCH, VA, 22041, US

(21) Appl. No.: 11/790,293

(22) Filed: Apr. 24, 2007

(30) Foreign Application Priority Data
Oct. 24, 2006 (CN) 200620029492.8

(51) Int. Cl. F21S 4/00

(52) U.S. Cl. 362/219

(57) ABSTRACT

An LED (Light-Emitting Diode) lamp bank is primarily formed with a plurality of LED lamps, a soft substrate, conduction wires, and soft vinyl. Two ends of each LED lamp bank are provided with female socket holes to connect with male connection terminals serially. A hard protective sheet is located at a position of the soft vinyl where each LED lamp is located, such that shear force of the soft vinyl at the location of the LED lamp can be increased, and an ill condition of fracture caused by stress concentration at the location of the LED lamp can be effectively prevented when the LED lamp bank is bended.

### BACKGROUND OF THE INVENTION

(a) Field of the Invention

The present invention relates to an LED (Light-Emitting Diode) lamp bank, and more particularly to an LED lamp bank which is designed as being easily connected in serial and having large shear force, without being easily concentrated with stress, against a conventional LED lamp bank which is provided with shortcomings that it is troublesome to connect the LED lamp bank serially, that the LED lamp bank is not convenient to use, and that it is easy to cause fractures at locations of the LED lamps when the LED lamp bank is bended.

(b) Description of the Prior Art

For an LED (Light-Emitting Diode), a principle that electric energy can be directly transformed into light energy, is used to apply voltage to terminals of positive and negative electrodes in a semiconductor, such that when electric current passes through the terminals, electrons and electron holes are combined to release the rest of energy in terms of light. Therefore, heat generated by the LED will be extremely low, power consumed by the LED will be very small, and lifetime of usage for the LED will be very long; wherein the low heat generation and small power consumption are all resulted from a feature of operation with low voltage and low current. In terms of environmental protection, the LED can be recycled, without turning into a waste which pollutes the environment. Therefore, the LED has been commonly designed to serve as illuminating equipment for the next generation. According to objects of application, multiple LEDs can now be permitted to be assembled into subtitles or lamp decorations, and are widely made into banks of lamps which are serially connected, allowing people to arrange a light projection effect of the assembly of LED lamp banks, according to requirements.

Referring to FIG. 1 and FIG. 2, it shows two kinds of structure of an existing LED lamp bank, and FIG. 3 shows a simplified circuit diagram, wherein a pin of an LED lamp 13 is connected to a resistor 14, and then two pins are connected respectively with positive and negative conduction wires. As shown in FIG. 1, its structure includes a soft substrate 16, conduction wires 18A, 18B, the LED lamps 13, resistor elements 14 (not shown in the drawing), and a soft vinyl 17 which encloses at an exterior. Two pins of the LED lamp 13 are all located at one side of the soft substrate 16, and the positive, negative conduction wires 18A, 18B are located respectively at each side of the substrate 16, thereby facilitating a finishing work. One pin of the LED lamp 13 is directly welded on the conduction wire 18B at the same side, with a soldering tin 15, and on the soft substrate 16, at a position corresponding to the other pin of the LED lamp 13, is provided with a hole (not shown in the drawing) to be corresponding to the conduction wire 18A at the other side. When the soldering tin 15 is added, the conduction wire 18B will be connected with the conduction wire 18A at the other side through the hole, thereby accomplishing a parallel circuit for the LED lamp. After that, the soft vinyl 17 is poured in, and then an LED lamp bank structure as shown in the drawings will be formed. On the other hand, FIG. 2 shows another structure constructed by a surface mounted technology (SMT). This kind of lamp bank is provided with a small volume. As shown in FIG. 2, each single LED lamp 13 is fitted with an electronic element 14 at its neighbor, two conduction wires 18A, 18B are located at a bottom of the soft substrate 16, and the LED lamp 13 is directly mounted on the soft substrate 16, with two holes (not shown in the drawing) being used as positive and negative electrodes at the location of LED lamp 13 on the soft substrate 16, for connecting to the two conduction wires 18A, 18B, respectively. Accordingly, after the LED lamp 13 is mounted on the soft substrate 16, a loop will be formed by the LED lamp 13 and the two conduction wires 18A, 18B. In addition, as the volume is smaller, fewer soft vinyls 17 can be poured in.

As the LED lamp bank is provided with good flexibility, it can be bended into a required pattern (as shown in FIG. 5). Although the LED lamp bank is provided with the good flexibility, it is very common that a fracture will easily occur at a position of the LED lamp 13 when the LED lamp bank is bended in use, as shown in FIG. 6 and FIG. 12. As a distance Y from two ends or a bottom end of the soft vinyl 17 where the LED lamp 13 is located, to an outer periphery of the soft vinyl 17 of the LED lamp bank is the shortest (as shown in FIG. 7 and FIG. 13), meaning that other cross sectional area at the position of the soft vinyl 17 where no LED lamp 13 is located will be the largest, while the cross sectional area at the position of the soft vinyl 17 where the LED lamp 13 is located, will be the smallest; therefore, stress will be most concentrated on the cross section of the soft vinyl 17 across the distance Y, and that cross section is also subjected to the largest force, when the LED lamp bank is bended. Accordingly, it is the reason why that the LED lamp bank is usually fractured easily, when the LED lamp bank is in use.

On the other hand, in a serial connection method for a conventional LED lamp bank, a power input end is used to provide two designated power input terminals or wires, which allows consumers or on-site implementation persons to connect the power input end of the conventional LED lamp bank to a power supply when serially connecting the LED lamp bank, thereby enabling the LED lamp bank to illuminate. When more than a second or a third LED lamp bank is to be connected serially, same amount of wirings should be connected from the power supply. Results of this serial connection will be that the more the LED lamp banks are, the longer the serial connection is, and the longer the wirings which are provided by the power supply to tail ends of the serially connected LED lamp banks are, and correspondingly, the larger the impedance is generated. Accordingly, electric current will have to be increased by the power supply to cope with the power which is supplied to the LED lamp banks at its tail end. In addition, the more the serially connected LED lamp banks are, the more the wirings are used, which results in that a user will be hard to implement by oneself, as too many wirings are exposed out, and thus requiring professionals to do the implementation. Furthermore, a lot of time will be wasted to deal with the exposure of the wirings, which is not pretty and difficult to implement.

There is another kind of LED lamp bank with female socket holes at one end, and a male connection terminal at the other end, such that the LED lamp banks can be serially connected by mutually combining the male socket holes and the male connection terminals, thereby preventing the wirings from being connected externally. However, as two ends of each LED lamp bank are provided respectively with the female socket holes and the male connection terminal, the implementation of serial connection will have to follow direction of the LED lamp bank; and as the male connection terminal at one end is exposed out, it will be easy to bend or fracture the LED lamp bank from external force. On the other hand, a short-circuiting phenomenon occurs easily to the LED lamp bank, from being stained by moisture during the implementation, which is an obvious shortcoming in current application.

### SUMMARY OF THE INVENTION

The primary object of present invention is to provide an LED (Light-Emitting Diode) lamp bank which is provided with enhanced shear force at locations of the LED lamps, and is provided with an effect that a fracture does not occur easily.

Another object of the present invention is to provide an LED lamp bank which is provided with hard protective sheets at locations of the LED lamps, so as to protect strength and shear force at the locations of the LED lamps.

Still another object of the present invention is to provide an LED lamp bank, wherein the LED lamp bank can be connected with each other serially by male connection terminals, so as to simplify an implementation and increase beauty.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an embodiment of a conventional two-pin LED (Light-Emitting Diode) lamp bank.

FIG. 2 shows a schematic view of an embodiment of a conventional LED lamp bank produced by a surface mounted technology.

FIG. 3 shows a simplified circuit diagram of a conventional LED lamp bank.

FIG. 4 shows a schematic view of an embodiment of an LED lamp bank which is connected serially.

FIG. 5 shows a schematic view of an embodiment of an LED lamp bank which is in use.

FIG. 6 shows a schematic view of a shortcoming of a conventional LED lamp bank.

FIG. 7 shows a cross-sectional view of a conventional LED lamp bank of FIG. 6.

FIG. 8 shows a schematic view of an embodiment of the present invention which is added with a hard protective sheet.

FIG. 9 shows a schematic view of a second embodiment of the present invention which is added with a hard protective sheet.

FIG. 10 shows a schematic view of a structure of a hard protective sheet having a closed holding space.

FIG. 11 shows a schematic view of a structure of a hard protective sheet having an open holding space.

FIG. 12 shows a second schematic view of a conventional LED lamp bank.

FIG. 13 shows a cross-sectional view of a conventional LED lamp bank of FIG. 12.

FIG. 14 shows a schematic view of an embodiment of FIG. 12, which is added with a hard protective sheet, according to the present invention.

FIG. 15 shows a cross-sectional view of an LED lamp bank of FIG. 14.

FIG. 16 shows a schematic view of an embodiment of the present invention which is added with a circuit board as a hard protective sheet.

FIG. 17 shows a cutaway view of FIG. 16.

FIG. 18 shows a schematic view of an embodiment of the present invention using a thickened soft vinyl as a hard protective rubber.

FIG. 19 shows a cutaway view of FIG. 18.

FIG. 20 shows a schematic view of a second embodiment of the present invention using a thickened soft vinyl as a hard protective rubber.

FIG. 21 shows a cutaway view of FIG. 20.

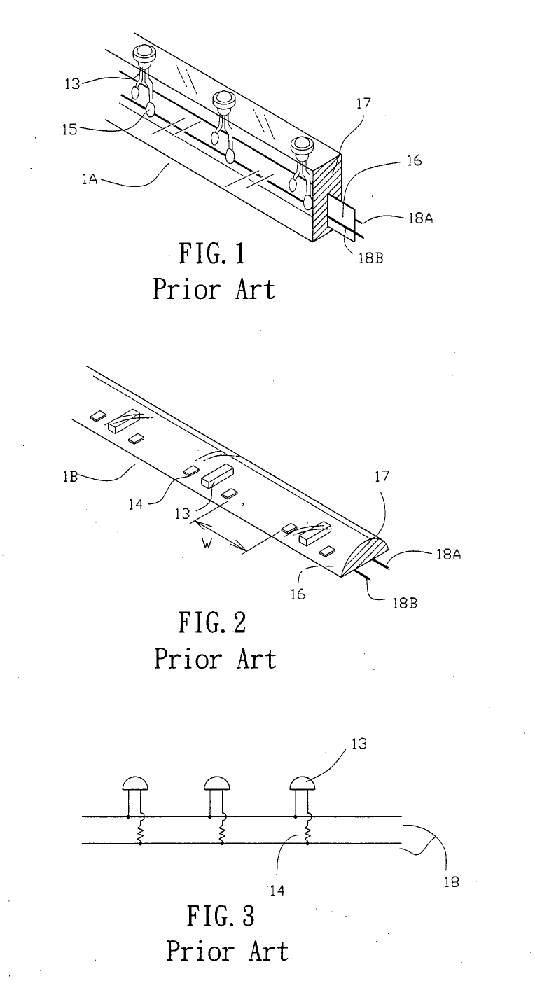

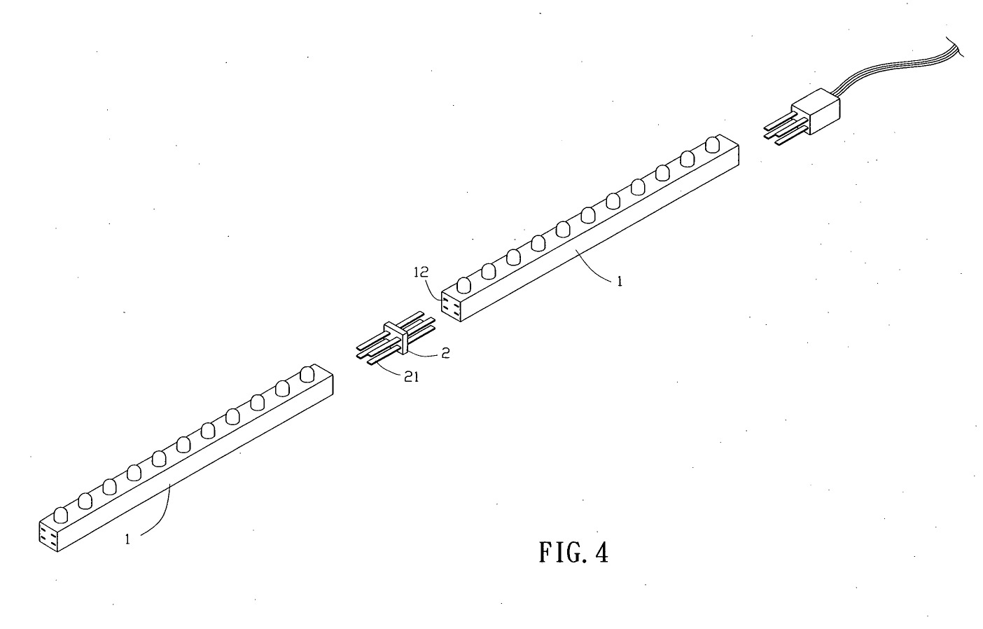

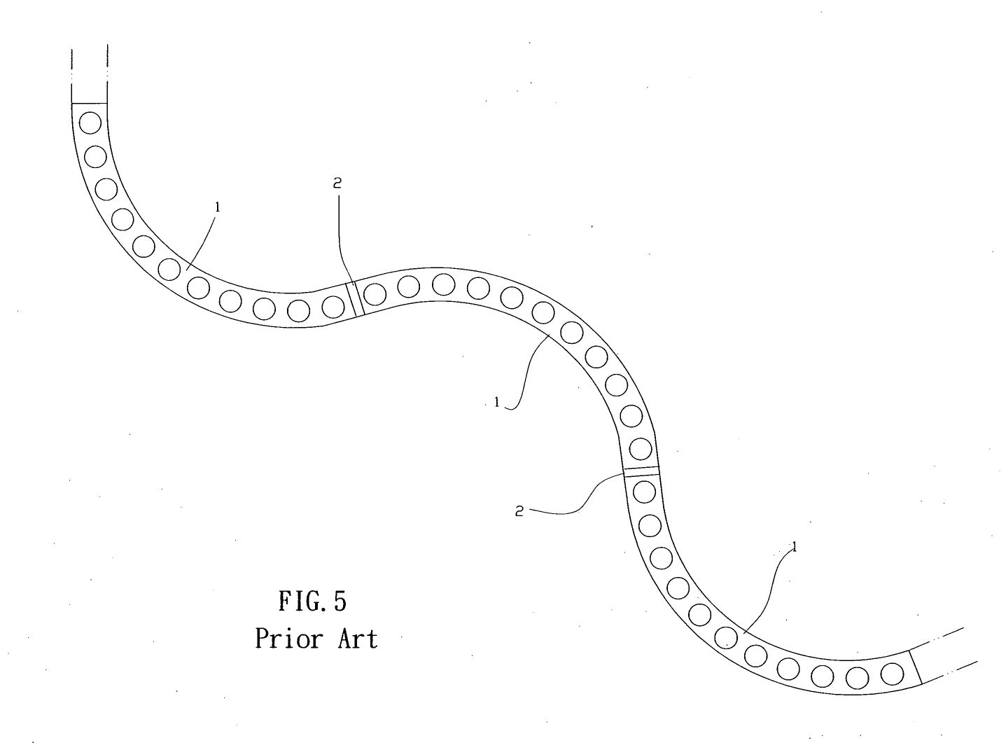

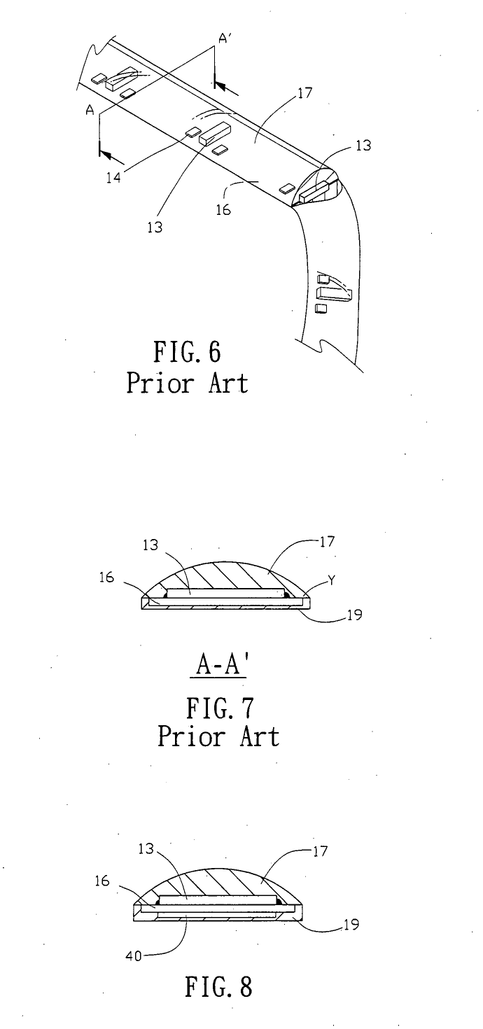

### DETAILED DESCRIPTION OF THE PREFERRED EMBODIMENTS

An LED (Light-Emitting Diode) lamp bank of the present invention allows an LED lamp bank 1 to connect with each other with a male connection terminal 2 to achieve effects of an easy implementation and beauty. Referring to FIG. 4, left and right end sides of the LED lamp bank 1 are provided with a same amount of female power socket holes 12 as that of the male connection terminals 2. In the drawing, there are four female seat holes 12, with each of which being provided with a positive and a negative electrode.

The male connection terminal 2 is provided with at least two-way pins 21 which can be inserted into the female socket holes 12 of the LED lamp bank 1, such that two LED lamp banks 1 can be connected serially by the two-way pins 21. Therefore, if a plurality of LED lamp banks 1 need to be connected serially, these male connection terminals 2 can be used to transmit power. By this design, in connecting the LED lamp bank 1 serially, as both ends of the bank are provided with the female socket holes 12 for connecting with the male connection terminals 2, there will be no limitation to directionality as in the prior art, and any end can be used for connection freely. In addition, it is not easy to result in a short-circuiting phenomenon from being stained with moisture during implementation.

On the other hand, the LED lamp bank 1 of the present invention is provided with a structure which is basically the same as that of the prior art, and includes the aforementioned soft substrate 16, conduction wires 18, LED lamps 13, and soft vinyl 17 which encloses at the exterior. In order to increase strength at a location of the LED lamp 13, a hard protective sheet is specifically installed at that location. Referring to FIG. 8, it shows a cross-sectional view of an LED lamp bank formed with a surface mounted technology. A hard protective sheet 40 is located below a protective pad 19 which holds the soft substrate 16, at the location of the LED lamp 13. This hard protective sheet 40 can exactly cover an area of the LED lamp 13, and therefore, even that when the LED lamp bank 1 is bended, it will not be bended at a range of the LED lamp 13, but over a region of the hard protective sheet 40, thereby preventing from a danger of fracture at the LED lamp 13, which serves as the bending location.

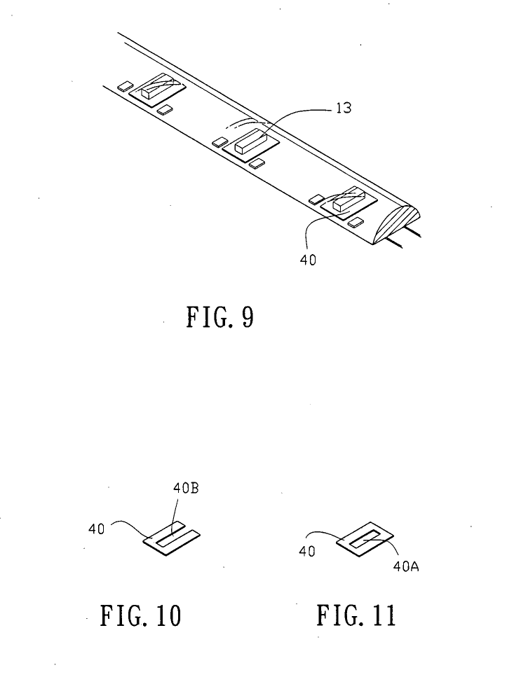

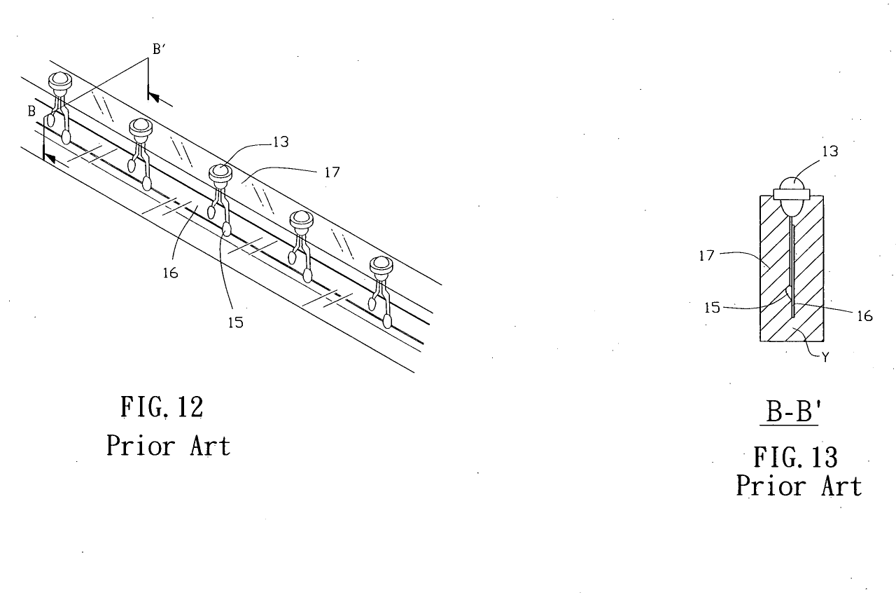

Referring to FIG. 9, it shows a schematic of an embodiment that the hard protective sheet 40 is located on the LED lamp 13, wherein the hard protective sheet 40 is provided with a closed holding space 40A for exposing the LED lamp 13, as shown in FIG. 10. Of course, the hard protective sheet 40 can be also designed to have an open holding space 40B, as shown in FIG. 11.

Other element that is related to the LED lamp 13 includes a resistor 14. If the bending of the LED lamp bank 1 will reduce a cross-sectional area of a soft vinyl where the related element is located, then it should also be covered by an area of the hard protective sheet 40.

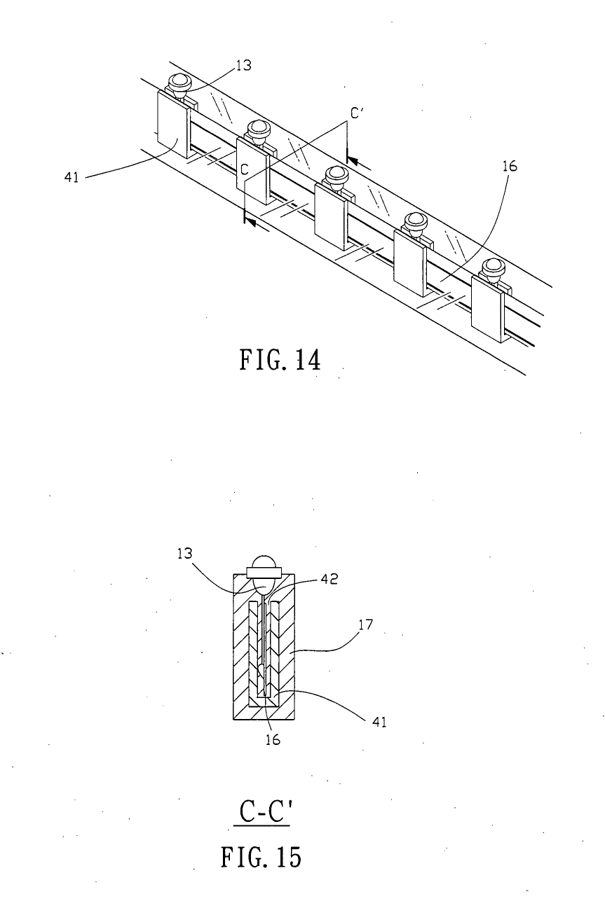

Furthermore, referring to FIG. 14, it shows a schematic of an embodiment of a two-pin LED lamp, wherein a hard protective sheet 41, which is provided with a holding space, is located on a position of the LED lamp 13. As shown in FIG. 15, the holding space is in a shape of a concaved part 42, and the pins of the LED lamp 13 can be sheathed in at positions of the soft substrate 16 to be covered in a front and a rear, so as to strengthen the position of the soft vinyl 17 where the LED lamp 13 is located. Therefore, when the LED lamp bank is bended, that position will not be bended directly due to a protection of the hard protective sheet 41, thereby preventing from an ill condition of the prior art that the LED lamp bank is easily fractured at the location of the LED lamp 13.

The hard protective sheet 41 is not limited to the concaved shape, but can be also in a plate shape to be located at a periphery of the LED lamp, as long as that it can protect the LED lamp from being bended easily.

In installing the above hard protective sheets 40, 41, a procedure of emplacing the hard protective sheet followed by pouring the vinyl can be included in an automatic operation process of the LED lamp bank, and can be controlled by an automatic procedure, without affecting its original manufacturing cost or increasing time of labor. The installation of the hard protective sheets 40, 41 can prevent from a dragging to compressing the LED lamp and the related element due to natural contraction in cold temperature and swelling in hot temperature under a long time of usage of the vinyl, thereby truly reducing a failure rate.

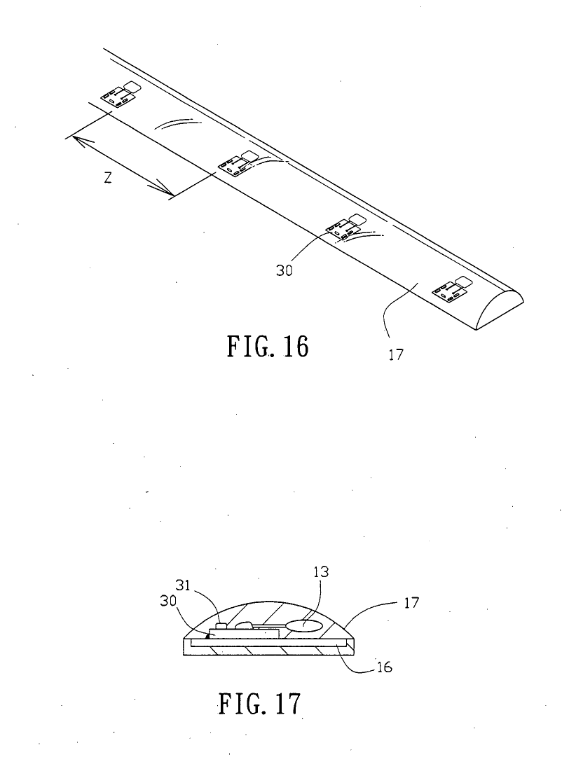

The hard protective design of the LED lamp bank of the present invention can be also arranged according to structural requirement for a shining control of the LED lamp. As shown in FIG. 16 and FIG. 17, the LED lamp 13 and a related electronic element 31 can be installed on a hard circuit board 30 and then are welded on the substrate 16, so as to enlarge a free bending space Z of each LED lamp 13, without decreasing a free bending space W (as shown in FIG. 2) of the prior art wherein a resistor 14 is located between the LED lamps 13; thereby allowing the hard circuit board 30 to be provided with a protection effect of the hard protective sheet. As the larger the free bending space is, the more convenience the arc and bending degree of the LED lamp bank are; thus the LED lamp bank can more develop a variation of original convenience in arranging a pattern.

The hard circuit board 30 can wrap and beautify a plastic according to requirement, thereby achieving another effect of beauty and having an effect of enhancing hardness.

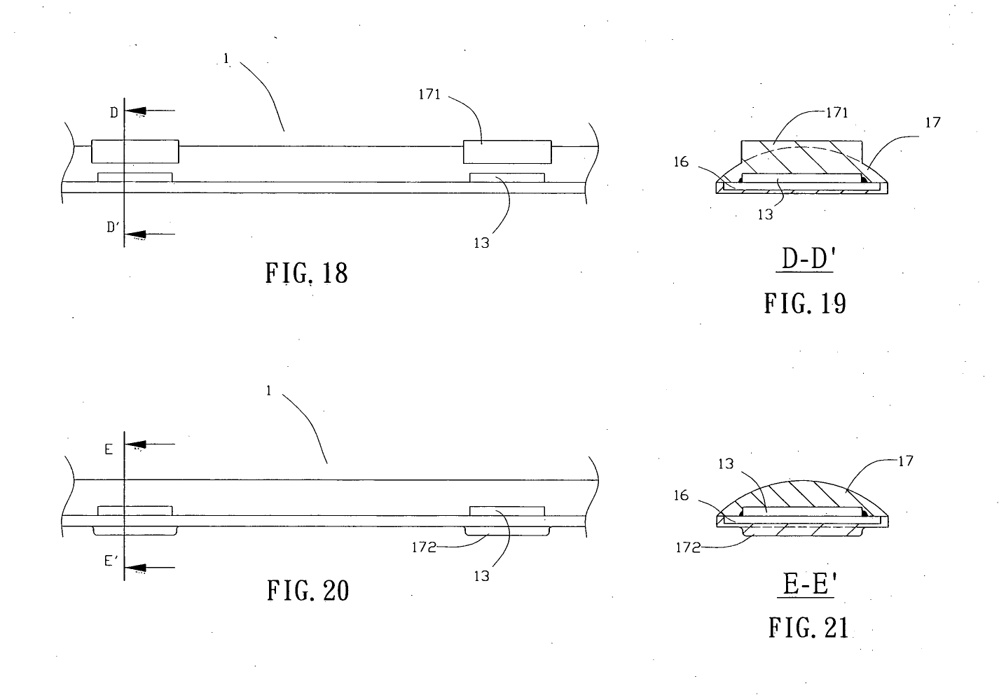

The hard protective sheet design of the LED lamp bank of the present invention can also thicken a part of the soft vinyl 17 where the LED lamp is located; that is, a thicken part 171 is formed above the position of the LED lamp 13 of the LED lamp bank, as shown in FIG. 18 and FIG. 19, or, a thicken part 172 is formed integrally on a part of the lower soft substrate 16 where the LED lamp 13 is located as shown in FIG. 20 and FIG. 21.

Accordingly, the LED lamp bank of the present invention really improves the shortcomings in using the conventional LED lamp bank, and provides an easy and convenient implementation method, thereby definitely providing an invention which saves time and labor, and is economic and practical.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED (Light-Emitting Diode) lamp bank being a single LED lamp bank which is constituted by conduction wires, LED lamps, a soft substrate, and soft vinyl enclosing at an exterior, wherein the LED lamps are located on the soft substrate; two ends of the LED lamp bank being provided with female socket holes to connect respectively with an equal amount of male connection terminals in serial, for achieving an effect of easily connecting the LED lamp banks serially; whereas, a hard protective sheet being located at each LED lamp having a smallest cross section of the soft vinyl for the LED lamp bank, thereby preventing the LED lamp bank from being damaged by bending.

2. The LED lamp bank according to claim 1, wherein the hard protective sheet is located below the soft substrate according to requirement.

3. The LED lamp bank according to claim 1, wherein the hard protective sheet is provided with a holding space for exposing the LED lamp, and is located on the soft substrate, at a same position of the LED lamp.

4. An LED lamp bank comprising a soft substrate, conduction wires, LED lamps, and soft vinyl which encloses at an external, wherein two ends of the LED lamp bank are serially connected with male connection terminals to serially connect the LED lamp bank, the LED lamps are located at sides of the soft substrate, and a hard protective sheet is located on a location of the soft substrate where cross section of the soft vinyl is the smallest.

5. The LED lamp bank according to claim 4, wherein the hard protective sheet is provided with a holding space to protect the LED lamp inside of which.

6. The LED lamp bank according to claim 4, wherein the hard protective sheet is in a plate shape and is located at two pins or the other side of the LED lamp.

7. The LED lamp bank according to claim 4, wherein if an electronic element related to the LED lamp results in a decrease of the cross section of the soft vinyl, such that electronic element is to be covered by the hard protective sheet.

8. An LED lamp bank being a single LED lamp bank which is constituted by conduction wires, LED lamps, a soft substrate, and soft vinyl which encloses at an external, wherein the LED lamp and a related electronic element are located on a hard circuit board, and then are welded on the soft substrate, enabling the hard circuit board to be located on the soft substrate, thereby forming a hard protective sheet which protects the LED lamp bank to prevent from being damaged at locations of the LED lamps, when the LED lamp bank is bended.

9. An LED lamp bank being a single LED lamp bank which is constituted by conduction wires, LED lamps, resistors, a soft substrate for emplacing the LED lamps and the resistors, and soft vinyl which encloses at an external, wherein the soft vinyl, which is located above or below the LED lamp on the substrate, is formed with an thickened part.
